(19) United States
(12) Patent Application Publication
(10) Pub. No.: US 2006/0068648 A1
(43) Pub. Date: Mar. 30, 2006

(54) Secondary battery module

(76) Inventors: Tae-Yong Kim, Suwon-si (KR); Yoon-Cheol Jeon, Suwon-si (KR); Gun-Goo Lee, Suwon-si (KR)

Correspondence Address: CHRISTIE, PARKER & HALE, LLP, PO BOX 7068, PASADENA, CA, 91109-7068, US

(21) Appl. No.: 11/233,302

(22) Filed: Sep. 21, 2005

(30) Foreign Application Priority Data
Sep. 24, 2004 (KR) 10-2004-0077052

(51) Int. Cl. H01R 4/38

(52) U.S. Cl. 439/766

(57) ABSTRACT

A secondary battery module includes a plurality of unit batteries and connectors for electrically connecting the unit batteries with one another, wherein each connector is fixed to terminals of the unit batteries by using at least a nut having a thread on its inner circumferential surface, and the inner circumferential surface of the nut is tapered.

### CROSS REFERENCE TO RELATED APPLICATIONS

This application claims priority to and the benefit of Korean Patent Application No. 10-2004-0077052 filed in the Korean Intellectual Property Office on Sep. 24, 2004, the entire disclosure of which is incorporated herein by reference.

### FIELD OF THE INVENTION

The present invention relates to a secondary battery cell, and more particularly, to a high-power and high-capacity secondary battery module.

### BACKGROUND OF THE INVENTION

Recently, a secondary battery using a non-aqueous electrolyte has been developed as a high density and high power energy source.

Typically, several to tens of the high power secondary batteries (hereinafter “unit batteries”) may be serially connected to form a module for driving motors of machines requiring a high power source such as a hybrid electric vehicle (HEV).

A unit battery typically includes an electrode assembly including a positive electrode, a negative electrode and a separator interposed between both the electrodes, a container having a space to receive the electrode assembly, a cap assembly fixed to the container to seal the container, and a positive terminal and a negative terminal protruding from the cap assembly to be electrically connected to the positive and negative electrodes of the electrode assembly, respectively.

To make a module including unit batteries, the unit batteries are typically alternately arranged such that the positive terminal and the negative terminal of a unit battery are crossed with the negative terminal and the positive terminal of a neighboring unit battery, respectively, and the terminals are connected to one another by using a conductive connector.

The conductive connector may be fixed to the terminal, for example, by a nut, so as not to be separated from the terminal. For this purpose, a screw thread is formed on the outer circumferential surface of the terminal.

As mentioned above, a conventional secondary battery module may have several to tens of unit batteries which are electrically connected to one another through a conductive connector using screws.

However, in such a secondary battery module structure two nuts are required per terminal to install a connector, thus increasing the possibility of nut installation errors as a larger number of nuts are used. Even when the nuts have been appropriately fastened, their engagement may become loosened depending on external conditions and they may ultimately become completely unscrewed.

Particularly when a secondary battery is applied to drive a high capacity motor for high capacity appliances such as a vacuum cleaner, an electric scooter, or an electric vehicle (e.g., a hybrid car), the nut attachment problem may become significant because continuous vibration and/or impact is applied to the secondary battery module depending on external conditions of such appliances.

In other words, since the secondary battery is constantly vibrated, impacted, and/or moved, and its temperature is usually not stable in such conditions, the nuts may become gradually loosened and eventually may become completely unscrewed.

If the nuts are loosened or unscrewed, the integrity of a corresponding secondary battery module is reduced, and the appliance having the secondary battery module may be degraded.

Thus, there is a need for a secondary battery module having improved integrity and resistance against internal vibration and/or external impact by reinforcing engagement of the nuts.

### SUMMARY OF THE INVENTION

According to one exemplary embodiment of the present invention, a secondary battery module is provided including a plurality of unit batteries and connectors for electrically connecting the unit batteries, wherein each connector is fixed to terminals of the unit batteries by using at least a nut having a thread on its inner circumferential surface, and the inner circumferential surface of the nut is tapered.

A portion of threads may be used to substantially fasten the nut to the terminal. An inner circumference of the nut may be gradually enlarged along a height of the nut from one side to the other side.

According to another exemplary embodiment of the present invention, a secondary battery module is provided including a plurality of unit batteries, first and second frames disposed at outermost unit batteries positioned at first and second ends of the module, respectively, at least one connection bar elongated between the frames, and at least one nut engaged with the connection bar for fixing the frames, wherein an inner circumferential surface of the nut is tapered.

### BRIEF DESCRIPTION OF THE DRAWINGS

FIG. 1 is a perspective diagram illustrating a conventional secondary battery module.

FIG. 2 is a cross-sectional diagram illustrating a nut used to engage a connector of a secondary battery module according to an embodiment of the present invention.

FIG. 3 is a front view illustrating a secondary battery module to which nuts according to an embodiment of the present invention are applied.

FIG. 4 is a top view illustrating a secondary battery module to which nuts according to an embodiment of the present invention are applied.

FIG. 5 is a cross-sectional view for describing an engagement state of the nuts according to an embodiment of the present invention.

FIG. 6 is a schematic block diagram showing a secondary battery module driving a motor according to the present invention.

### DETAILED DESCRIPTION

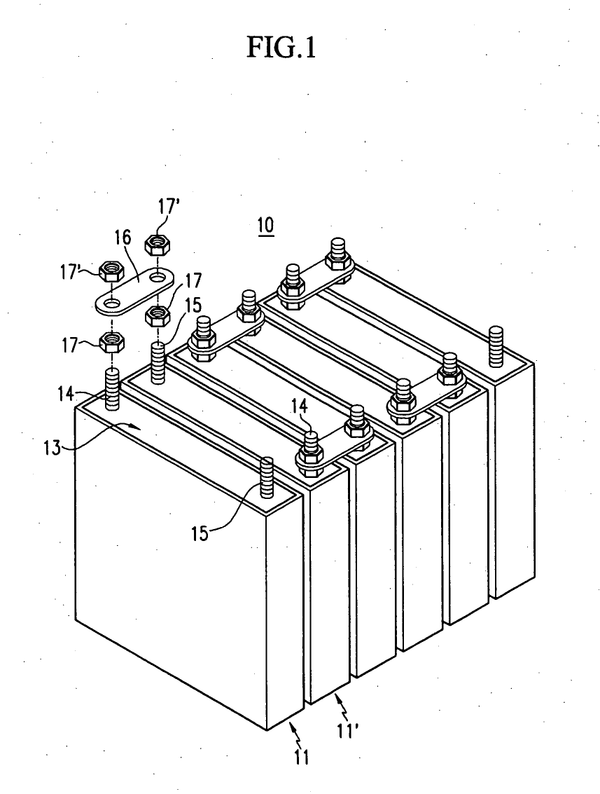

Referring to FIG. 1, the secondary battery module 10 has a plurality of unit batteries electrically connected with one another through connectors.

In such a secondary battery module 10, the positive terminals 14 and the negative terminals 15 are alternately arranged. Also, they protrude from the top surfaces of cap assemblies of the unit batteries 11, 11′, and their outer circumferential surfaces are threaded so that the nuts 17, 17′ are engaged with them to install the connectors 16.

Specifically, the positive and negative terminals 14, 15 have a bolt-like shape, and the first nuts 17 are engageable with them. A connector 16 may then be disposed on the terminals 14, 15 to connect a positive terminal 14 of a unit battery 11 to the negative terminal 15 of a neighboring unit battery 11′. Subsequently, the second nuts 17′ are engaged with the positive and negative terminals 14, 15 to fix the connector 16 to the terminals.

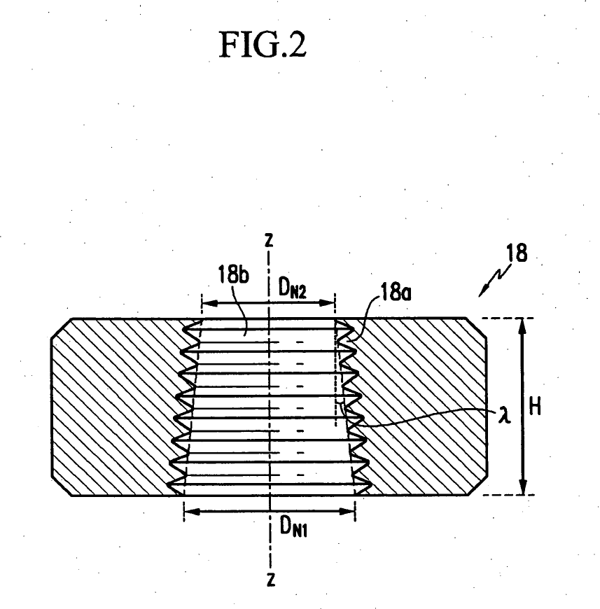

FIG. 2 is cross-sectional view illustrating a nut 18 that may be applied to the secondary battery module 10. According to an embodiment of the present invention, the inner circumferential surface of the nut 18 is tapered.

Referring to FIG. 2, it is recognized that the inner circumferential surface of the nut 18 is inclined in a predetermined angle with respect to the center axis Z of the nut 18. For a nut 18 with a tapered configuration, the inner diameter of the female screw hole 18b is enlarged along the height of the nut from one end to the other end (from the top surface to the bottom surface in FIG. 2), so that the diameter of the hole 18b on the top surface is smaller than the diameter on the bottom surface.

While the above description has been directed to the nut 18 for fixing the connector 16 according to an embodiment of the present invention, such a tapered inner circumferential surface structure may be applied to all the nuts of a secondary battery module as described below.

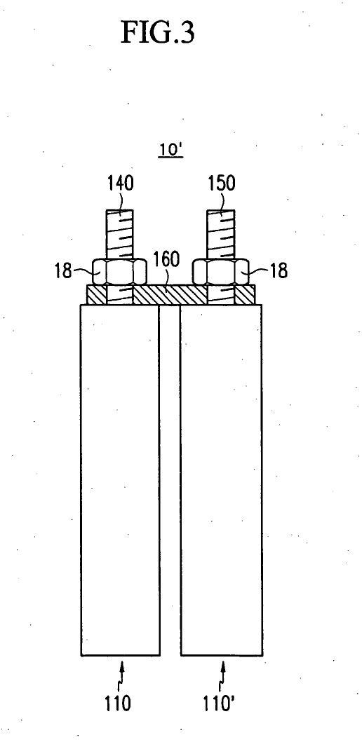

FIG. 3 illustrates that the nut 18 according to the present embodiment is applied for connection between positive and negative terminals 140, 150 of the unit batteries 110, 110′ of a battery module 10′.

Referring to FIG. 3, the connector 160 is engaged with the terminals 140 and 150 having a bolt-like shape and protruding toward the outside of the unit battery 11. The nuts 18 may be engaged with the terminals 140, 150 for fixing the connector 160. As described above, the nuts 18 may have a thread formed along the tapered inner circumferential surface.

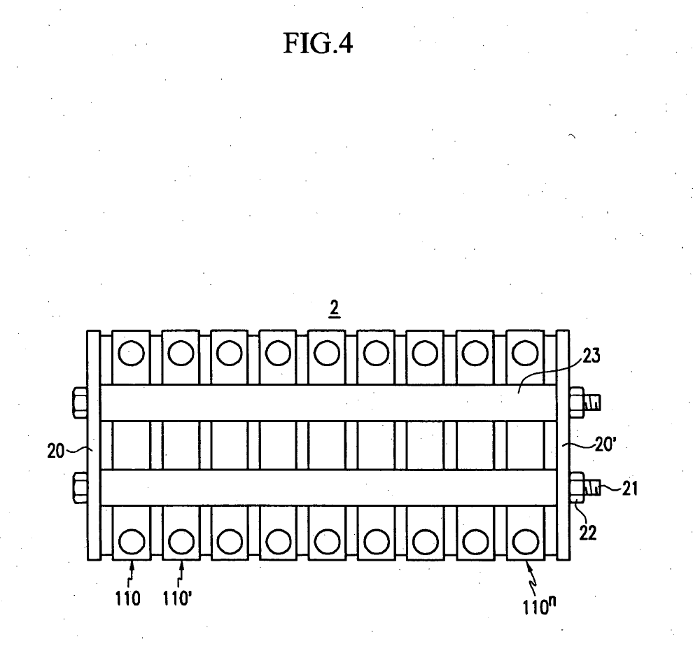

FIG. 4 illustrates an exemplary embodiment of a nut 22 having the above-described structure used for fixing frames 20, 20′ included in a secondary battery module 2 when the secondary battery module 2 is substantially assembled with the unit batteries 110, 110′ shown in FIG. 3.

In the secondary battery module 2, while a plurality of unit batteries 110, 110′, . . . , and 110ⁿ are arranged in a predetermined interval, frames 20, 20′ are disposed on the outermost unit batteries 110 and 110ⁿ. After the connection bars 23 are installed on the frames 20, 20′, the nuts are 22 engaged with the male screws 21 formed on the end of the connection bars 23. As a result, the tightening force generated is used to fix the unit batteries 110, 110′, . . . , and 110ⁿ to the frames 20, 20′.

The nut 22 engaged with the end of the connection bar 23 assembled with the frame 20 may have a tapered inner circumferential surface as shown in FIG. 2.

According to an exemplary embodiment, the taper angle λ satisfies the following equation:
0<Tan⁻¹{(D_{N1}−D_{N2})/2H}<(D_{N1}−D_{N2})/2H,

where, D_{N1} denotes a diameter of a larger hole of the nut 22, D_{N2} denotes a diameter of a smaller hole of the nut 22, and H denotes a height of the nut 22. The inclination angle A is substantially maintained within a range from 0 to 1.

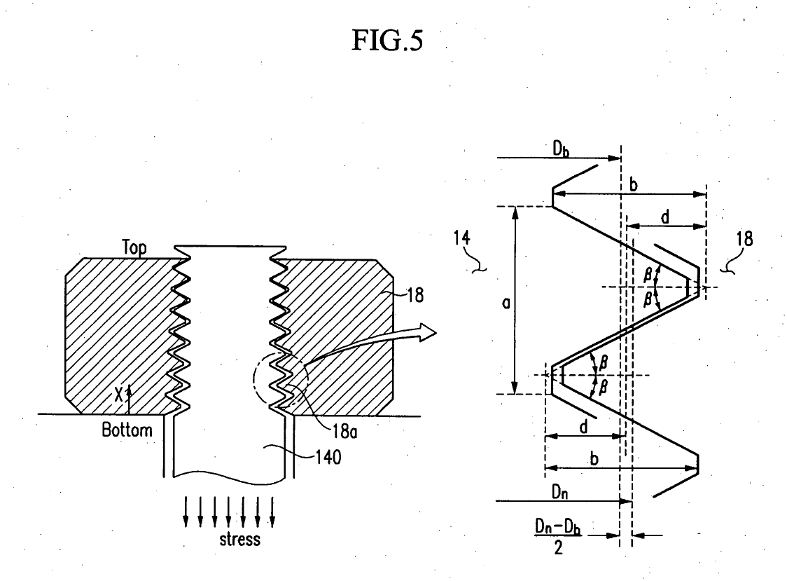

Now, the function of the nut 18 will be described in more detail with reference to FIG. 5. The load distribution in the screw portion of the bolt or the nut is not uniform along the length of the screw portion, and a first thread (from the bottom in FIG. 5) experiences a highest load. Therefore, damage to the screw portion is typically generated in the first thread.

However, in the nut 18 having a tapered inner circumferential surface according to the present embodiment, the load concentration in the first thread is attenuated, thereby obtaining uniform load distribution.

This fact is based on the following Equation proposed by Stoeckly and Macke in 1950, showing the stress distribution of a flat screw and a tapered screw along a length of a screw portion.

$$\frac{ω}{{ω}_{n}} = \frac{{ⅇ}^{- px}}{sinh {qx}_{o}} \{ ( 1 - k ) {ⅇ}^{{px}_{o}} ( q cosh qx - p sinh qx ) + k [ q cosh q ( {x}_{o} - x ) + p sinh q ( {x}_{o} - x ) ] \} \qquad ( 1 )$$

where, ω denotes a screw load generated by a shearing stress in the root portion of the thread, and ωₙ denotes a mean screw load obtained by averaging the screw loads for the entire screw portion. xₒ, p, q, and k are determined based on the following equations:

$${ⅇ}^{{px}_{o}} ( q cosh {qx}_{o} - p sinh {qx}_{o} ) = - \frac{kq}{1 - k}$$

$$p = \frac{L}{{Da}^{2}} υtanβ , q = \sqrt{{( \frac{2 L}{Da} )}^{2} + {p}^{2}}$$

$$λ = \frac{2 k σ A}{E tan β} ( \frac{1}{{A}_{b}} + \frac{1}{{A}_{n}} ) , {a}^{2} = \frac{ha}{AD ( \frac{1}{{A}_{b}} + \frac{1}{{A}_{n}} )} + H$$

$$h = - 4 ( 1 - {v}^{2} ) [ \frac{log c + ( 1 - c ) K}{2 β - sin 2 β} + \frac{H log c}{2 β + sin 2 β} + \frac{( 1 - c ) ( cos 2 β - c ) ( 1 + H )}{sin 2 β - 2 β cos 2 β} ]$$

$$H = \frac{tan β - μ}{cot β + μ} , K = \frac{1}{2 ( 1 - υ )} [ 1 + ( 1 - 2 υ ) \frac{2 β}{sin 2 β} ]$$

where, a denotes a pitch of a screw, b denotes a depth of a screw thread, d denotes a radius of a screw, c=d/b, D_{b}, denotes an outside diameter of a bolt, Dₙ denotes an inside diameter of a nut, A_{b}, Aₙ denote average areas of a bolt and a nut, D=(D_{b}+Dₙ)/2 denotes an average diameter, A=πD²/4 denotes an average area, L denotes a length of a nut, n denotes a number of threads, s denotes an interval in a bottom portion of a nut, s₁=πnD denotes the s value in the bottom portion of a nut, λ denotes a taper angle, λₒₚ denotes an optical taper angle, x=s/s₁, x₀ denotes an x value in a contact area of the bolt and the nut, β denotes a half of the screw angle, ω denotes a screw load, ωₙ=σA/πnD denotes an average screw load, E denotes an elasticity coefficient, ν denotes a Poisson ratio, μ denotes a friction coefficient, and ca denotes stress on the bolt while fastening the bolt to the nut.

Based on the above Equation (1) relating to the load distribution of the tapered screw, the screw load of a flat screw having a taper angle of 0 degrees can be expressed as follows:

$$\frac{ω}{{ω}_{n}} = \frac{{ⅇ}^{p ( 1 - x )}}{sinh q} ( q cosh qx - p sinh qx ) , \qquad ( 2 )$$

Based on the above equations, it is recognized that

$$\frac{ω}{{ω}_{n}}$$

becomes 3 or higher in a flat screw. This means that the load on a first thread is three or more times an average screw load.

However, if the inner circumferential surface of the nut 18 is tapered as shown in FIG. 5, it is possible to distribute the load carried by the first thread of a flat screw, and thereby obtain uniform load distribution in the screw portion.

In this case, the angle of the inner circumferential surface of the nut 18 with respect to the outer circumference of the terminal 140 is not particularly limited.

Accordingly, a relatively uniform load can be applied to the root portion of the thread of the positive and negative terminals 140, 150 in a unit battery 110, 110′. As a result, while a ratio of a maximum shearing stress with respect to an average shearing stress may be 4.86 in a conventional nut structure, the ratio can be reduced to 2.5 in a nut structure according to the present invention.

The secondary battery having the above-described nut structure may be used as an energy source for driving motors of appliances such as a hybrid electricity vehicle (HEV), an electrical vehicle (EV), a wireless vacuum cleaner, an electrical bicycle, and an electrical scooter.

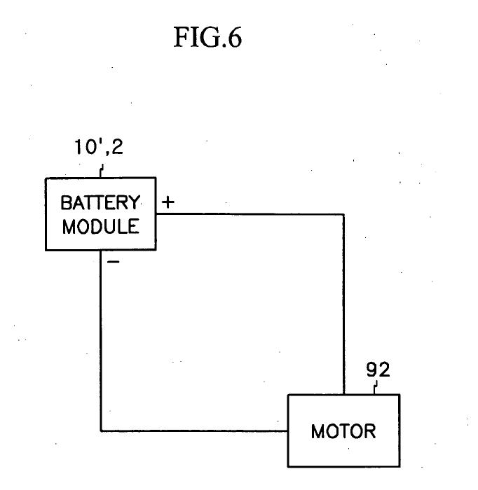

FIG. 6 is a schematic block diagram of a secondary batter module 10′, 2 having a nut as discussed in FIGS. 2 to 5 driving motor 92.

According to embodiments of the present invention, engagement forces of nuts are improved, thereby preventing nuts from being loosened by internal vibrations or external impacts in a secondary battery module. Additionally, the possibility of damage to nuts may be reduced thereby improving integrity and reliability of a secondary battery module.

Although exemplary embodiments of the present invention have been described, the present invention is not limited to these embodiments, but rather may be modified in various forms without departing from the scope of the appended claims, the detailed description, and the accompanying drawings of the present invention. Therefore, such modifications are within the scope of the present invention.

What is claimed is:

1. A secondary battery module comprising a plurality of unit batteries and a plurality of connectors for electrically connecting the plurality of unit batteries to one another,
wherein each connector is fixed to a terminal of a unit battery by using at least one nut, the nut having a thread on an inner circumferential surface, and
wherein the inner circumferential surface of the nut is tapered.

2. The secondary battery module according to claim 1, wherein a portion of the thread is used to substantially fasten the nut to the terminal.

3. The secondary battery module according to claim 2, wherein the inner circumference of the nut is gradually enlarged along a height of the nut from a first end to a second end.

4. The secondary battery module according to claim 1, wherein the secondary battery module is usable to drive motors.

5. A secondary battery module comprising a plurality of unit batteries connected to each other, a first frame disposed at a unit battery positioned on a first end of the secondary battery module, a second frame disposed at a unit battery positioned on a second end of the secondary battery module, at least one connection bar elongated between the first frame and the second frame, and at least one nut engaged with the at least one connection bar for fixing the first frame and the second frame,
wherein an inner circumferential surface of the nut is tapered.

6. The secondary battery module according to claim 5, wherein a portion of the thread is used to substantially fasten the nut to the terminal.

7. The secondary battery module according to claim 5, wherein the inner circumference of the nut is gradually enlarged along a height of the nut from one side to the other side.

8. The secondary battery module according to claim 5, wherein the secondary battery module is usable to drive motors.

9. A nut for a secondary battery module, the secondary battery module having a plurality of unit batteries and a plurality of connectors for electrically connecting the plurality of unit batteries to one another,
wherein the nut has a threaded inner circumferential surface;
the threaded inner circumferential surface of the nut is tapered; and
wherein the nut is adapted to fix a connector to a terminal of a unit battery.

10. The nut of claim 9, wherein a portion of the threaded inner circumferential surface is used to substantially fasten the nut to the terminal.
